(19) United States
(12) Patent Application Publication
(10) Pub. No.: US 2016/0238394 A1
(43) Pub. Date: Aug. 18, 2016

(54) Device for Estimating Position of Moving Body and Method for Estimating Position of Moving Body

(71) Applicant: HITACHI, LTD.., Chiyoda-ku, Tokyo (JP)

(72) Inventors: Taiki IIMURA, Tokyo (JP); Ryoko ICHINOSE, Tokyo (JP); Kenjiro YAMAMOTO, Tokyo (JP)

(21) Appl. No.: 15/024,687

(22) PCT Filed: Oct. 1, 2013
(86) PCT No.: PCT/JP2013/076673

§ 371 Date: Mar. 24, 2016

(51) Int. Cl. G01C 21/00; G06T 7/20; G06T 1/00

(52) U.S. Cl. CPC G01C 21/005; G06T 1/0014; G06T 7/20; G06T 2207/30241

(57) ABSTRACT

The present invention addresses the problem of reducing the processing load involved in estimating the position of a moving body. An upward-oriented camera is mounted to a top part of a moving body and an image of a periphery of the moving body is captured. A map management unit associates coordinates of a feature point extracted from the image taken of a peripheral environment with a map and manages the coordinates. A feature point tracking unit tracks a predetermined feature point selected by a predetermined reference from among feature points extracted from an image taken by an imaging unit. A feature point number management unit performs management so that the number of predetermined feature points tracked by the feature point tracking unit is a prescribed number. A position can be estimated from the coordinates of the predetermined feature point tracked by the feature point tracking unit and the map managed by the map management unit.

### TECHNICAL FIELD

The present invention relates to a device for estimating a position of a moving body and a method for estimating a position of a moving body.

### BACKGROUND ART

Devices for estimating a position of a moving body such as a robot and an automobile are conventionally known. In conventional techniques, the moving body is equipped with an internal sensor such as an encoder and a gyro sensor, and an external sensor such as a camera, a positioning satellite signal receiver (GPS), and a laser distance sensor, and estimates the position of the moving body based on a detection value from those sensors.

PTL 1 includes an image acquisition means configured to obtain an image of a moving body in a front field of view, a distance image acquisition means having a same field of view as the image acquisition means and configured to obtain a distance image while the image acquisition means acquires an image, a feature point extraction means configured to extract a feature point from each of at least two continuous frame images, and a reference feature point selection means configured to calculate a displacement of a position between the two frames of feature point extracted by the feature point extraction means based on the distance image and to select a reference feature point for calculating a self position from the displacement. According to PTL 1, a same stationary object is extracted from the two continuous frame images, a moving amount of the moving body is obtained from the displacement of the stationary object, and the position of the moving body is detected.

In PTL 2 includes a local map and a global map, and a result of matching between a landmark candidate extracted from an observation result obtained by an external sensor against a landmark registered on the global map is stored on the local map to be utilized for next landmark matching. According to PTL 2, a landmark candidate that does not match the landmark registered on the global map but matches the landmark candidate registered on the local map will be newly registered as a landmark on the global map. Further in PTL 2, a landmark that has not been observed for a long time is removed even if it is a registered landmark. According to a conventional technique described in PTL 2, by utilizing the result of matching between the landmark candidate and the landmark registered on the global map, it is possible to reduce the number to undergo direct matching between the landmark candidate and the landmark registered on the global map and to reduce the calculation amount. Also according to a conventional technique described in PTL 2, since the global map is sequentially updated based on the matching result of the landmark candidate, it is possible to flexibly cope with an environmental change.

### CITATION LIST

### Patent Literatures

PTL 1: Japanese Patent Application Laid-Open No. 2002-48513

PTL 2: Japanese Patent Application Laid-Open No. 2008-165275

### SUMMARY OF INVENTION

### Technical Problem

In a conventional position estimation method using a camera, a moving amount of a moving body is calculated based on a displacement of a feature point detected from an image, and the moving amount is added to a position previously calculated, thereby estimating a current position of the moving body. With this method, however, in a case where a feature point having a varying absolute position has been detected, errors of the moving amount of the moving body might accumulate.

In PTL 1, since a stationary object is discriminated based on translational moving amounts of all of the feature points tracked under stereoscopic monitoring and the position of the stationary object is used as a reference, it is possible to reduce accumulating errors of the self position. However, the translational moving amount of the feature point when the moving body is rotated depends on a distance between the moving body and the feature point. Therefore, with PTL 1, in a case where the distance between the moving body and each of objects is not even, it is difficult to discriminate whether the objects are stationary objects. Also, with PTL 1, extraction of necessary and sufficient numbers of feature points is difficult under an environment with few features, discrimination of the stationary object would be difficult.

Accordingly, techniques that have been proposed include a technique to prepare a map on which a position of an invariable feature point is registered and a technique (PTL 2) to reduce accumulating error of the position by combining an internal sensor such as an encoder, and a camera, without depending on peripheral environments.

According to PTL 2, a map of a landmark with an invariable position is prepared and a landmark candidate is detected by an external sensor such as a laser distance sensor and a camera. According to PTL 2, a position of the landmark candidate is calculated based on a provisional position calculated from a value of the internal sensor such as an encoder, and the landmark candidate is matched against the map. Processing load for matching the landmark candidate and the map each instance is high. Therefore, in PTL 2, a landmark candidate previously matched against the map is associated with a present landmark candidate, thereby reducing the number of direct matching between the present landmark candidate and the map. Under an environment where a large number of landmark candidates are detected simultaneously, however, the processing load generated for associating the previous landmark candidate with the present landmark candidate would increase.

Furthermore, when a position of a moving body is estimated, position estimation accuracy deteriorates by the amount of movement of the moving body during calculation time of estimation processing. Particularly in a case of a high-speed moving body such as an automobile that moves largely within one calculation time range, reducing the processing load to achieve high speed in calculation as much as possible would be critical.

The present invention is made in view of the above-described problem and the object of the present invention is to provide a moving body position estimation device and a moving body position estimation method, capable of reducing processing load needed for position estimation of the moving body. Another object of the present invention is to provide a moving body position estimation device and a moving body position estimation method whereby it is possible to estimate the position of the moving body with relatively small processing load by obtaining a prescribed number of predetermined feature points meeting a predetermined reference and by solely tracking the prescribed number of predetermined feature points.

### Solution to Problem

For the purpose of solving the above-described problem, a moving body position estimation device according to an aspect of the present invention includes an imaging unit attached to a moving body and configured to image a peripheral environment, a map management unit configured to manage coordinates of a feature point extracted from a captured image of the peripheral environment in association with a map, a feature point tracking unit configured to track a predetermined feature point selected by a predetermined reference among the feature points extracted from the image captured by the imaging unit, a feature point number management unit configured to manage such that the number of predetermined feature points tracked by the feature point tracking unit is a prescribed number, and a position estimation unit configured to estimate a position based on coordinates of the predetermined feature point tracked by the feature point tracking unit and based on the map managed by the map management unit.

It is also possible to configure such that a provisional position calculation unit is provided to calculate a provisional position and an attitude of the moving body based on a detection value of an internal state detection unit configured to detect an internal state of the moving body and based on a position estimated by the position estimation unit, and that the feature point tracking unit tracks the predetermined feature point using the provisional position and the attitude calculated by the provisional position calculation unit and using the image captured by the imaging unit.

The map management unit can manage, in association with the map, an image of a peripheral environment, an imaging position and an attitude when the image is captured, on-the-image coordinates of the feature points on the image, extracted from the image, and three-dimensional coordinates on a moving body coordinate system of the feature point.

The feature point tracking unit can calculate emergence expectation coordinates on which a predetermined feature point is expected to emerge on an image based on the provisional position calculated by the provisional position calculation unit, extract a feature point from the image within a predetermined region set to include the emergence expectation coordinates, calculate a matching likelihood between the extracted feature point and the predetermined feature point, and can use the feature point having the maximum matching likelihood as the predetermined feature point, among the feature points extracted within the predetermined region.

In a case where the feature point number management unit has determined that the number of predetermined feature points is less than a prescribed number, the feature point number management unit can execute matching processing between an image of the peripheral environment managed by the map management unit and the image captured by the imaging unit, and can accordingly add a feature point having a matching likelihood of a predetermined threshold or above and meeting a predetermined reference, as a new predetermined feature point.

In a case where the feature point number management unit has determined that the number of predetermined feature points is the prescribed number, the feature point number management unit can check whether each of the predetermined feature points meets a predetermined reference, judge that the feature point that does not meet the predetermined reference is not the predetermined feature point, and exclude the feature point from tracking targets for the feature point tracking unit, executes matching processing between the image of the peripheral environment managed by the map management unit and the image captured by the imaging unit, and can accordingly add a feature point having a matching likelihood of a predetermined threshold or above and meeting the predetermined reference, as a new predetermined feature point.

### Advantageous Effects of Invention

According to the present invention, since it is only required to track the prescribed number of predetermined feature points, it is possible to estimate the position of the moving body with reduced processing load.

### BRIEF DESCRIPTION OF DRAWINGS

FIG. 1 is a block diagram illustrating a functional configuration of a moving body and a moving body position estimation device.

FIG. 2(a) illustrates a state of a captured image. FIG. 2(b) illustrates a state in which a position of a moving body is estimated by tracking a target while managing the number of feature points as tracking targets.

FIG. 3 is exemplary map data managed by a map management unit.

FIG. 4 is a flowchart illustrating tracking processing.

FIG. 5 is a diagram illustrating exemplary tracking.

FIG. 6 is a flowchart illustrating feature point management processing.

FIG. 7 is a diagram illustrating exemplary management of a feature point.

FIG. 8 is a flowchart illustrating feature point management processing according to a second example.

FIG. 9 is a diagram illustrating exemplary management of a feature point.

FIG. 10 is a diagram illustrating another example of management of the feature point.

### DESCRIPTION OF EMBODIMENTS

Hereinafter, embodiments of the present invention will be described with reference to the drawings. In the present embodiment, as described below, a predetermined feature point that meets a predetermined reference is exclusively selected as a tracking target from among images captured by an imaging unit, and a position of a moving body is estimated based on coordinates of a prescribed number of predetermined feature points. With this procedure, according to the present embodiment, it is possible to reduce a processing load of the predetermined feature point needed for position estimation of the moving body. Furthermore, according to the present embodiment, the reduced processing load would lead to an increase in a processing speed, making it possible to estimate the position of a high-speed moving body such as an automobile.

### Example 1

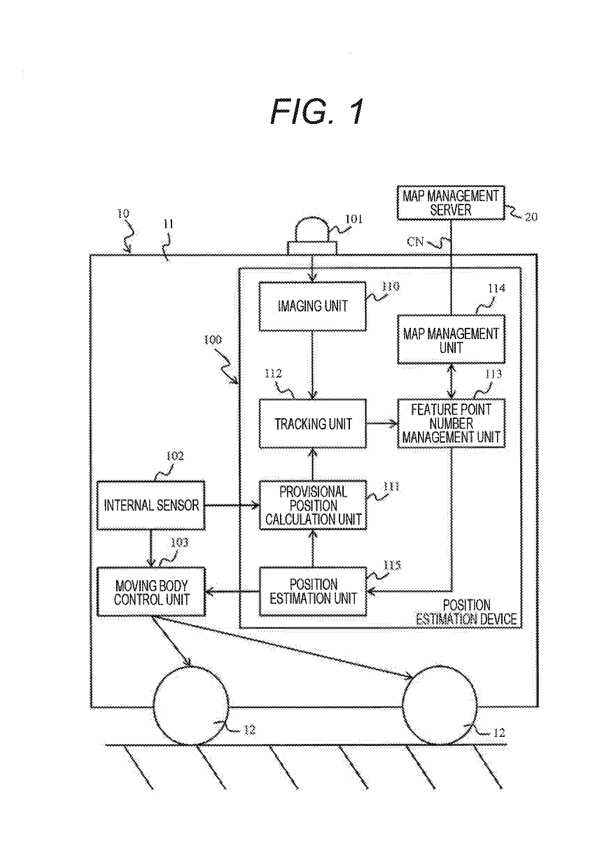

A first example will be described with reference to FIGS. 1 to 7. In the present example, as described below, a wide-angle camera 101 capable of imaging a wide range of area is mounted upwardly on an upper portion of a moving body 10 such as an automobile and a robot. A position estimation device 100 mounted on the moving body 10 extracts a prescribed number of feature points needed to estimate the position of the moving body 10 from among a large number of feature points within the wide range of area, thereby estimating the position of the moving body 10 with relatively low processing load.

The “feature point” described below corresponds to an invariant feature quantity in image processing. For example, the invariant feature quantity is represented by a point group forming a point or a line, having a direction in which inclination of a luminance value of a neighboring pixel is great, such as a corner or an edge forming an outline of a building and a window. Among feature points, a feature point to be a tracking target for position estimation is referred to as a predetermined feature point.

The “on-the-image coordinates” are two-dimensional orthogonal coordinates formed in vertical and horizontal directions on an image, allocating one pixel, namely, a minimum unit of the image, to one scale. The “three-dimensional coordinates” is Cartesian coordinates in which an arbitrary point is defined as a zero point. The “moving body coordinate system” is a coordinate system in which a front direction of the moving body is defined as an X-axis, a lateral direction of the moving body is defined as a Y-axis, and a height direction of the moving body is defined as a Z-axis. Since the position estimation device 100 used for estimating the position of the moving body 10 is mounted on the moving body 10, position estimation can also be expressed as “self position estimation”.

FIG. 1 is a block diagram illustrating a functional configuration of the moving body 10 and a functional configuration of the position estimation device 100. The moving body 10 is, for example, an automobile such as a passenger vehicle, a robot having a moving function, a movable object such as a construction machine.

The moving body 10 has a vehicle body 11 below which there is provided, for example, a moving mechanism 12 formed with a tire, or the like. The moving mechanism 12 is only required to be a mechanism for moving the vehicle body 11, and may be a wheel, crawler, walking leg, or the like.

The moving body 10 includes, for example, a camera 101, an internal sensor 102, and a moving body control unit 103 in addition to the position estimation device 100. The position estimation device 100, as described below, includes, for example, an imaging unit 110, a provisional position calculation unit 111, a tracking unit 112, a feature point number management unit 113, a map management unit 114, and a position estimation unit 115.

In order to detect a feature point around the moving body 10 from an area that is as wide as possible, it is desirable that the camera 101 is a wide-angle camera equipped with a wide-angle lens. Furthermore, in order to detect a feature point with an invariable position in an environment having a mixture of various objects with variable positions such as pedestrians and other moving objects, it is desirable that the camera 101 is installed upwardly on an upper portion of the moving body 10. When it is possible to extract a plurality of feature points from around the moving body 10, it would not matter types and installation position of the camera 101. The camera may be a single-eye camera using one camera, or a multiple-eye camera using a plurality of cameras.

The camera 101 includes a communication means to communicate with the imaging unit 110. Examples of the communication means include a communication protocol of picture transfer protocol (PTP) to transfer an image with universal serial bus (USB) connection, a communication protocol of PTP/internet protocol (IP) to transfer an image via a local area network (LAN) connection. It is only required that the means can transfer an image, and thus, the means is not limited to the above-described communication means.

The imaging unit 110 detects an image of a peripheral environment using the camera 101 and passes the detected image to a tracking unit 112 described below. The image of the peripheral environment includes an image of an object existing around the moving body, such as a building, a window frame, and furniture. Since the moving body 10 can travel not only outdoors but also in a room, the image of the peripheral environment includes an image of an object in the room. As an image, it is possible to use a grayscale image with pixels into each of which a 256-gradation luminance value has been embedded or a color image with pixels into each of which a color tone has been embedded.

When a color image is used, the color image is converted into a grayscale image using a bit conversion technique such as a known technique of grayscale conversion. The grayscale conversion includes a technique to convert a tone of one of three primary colors each of which having 256 gradations, into a luminance value, and a national television system committee (NTSC) weighted averaging technique, namely, a technique to convert a weighted average of tones of the three primary colors into a luminance value. Any technique can be used as long as it is a technique to convert a color tone into a luminance value.

In the present example, since image processing is performed in the dark and in the light indoors and outdoors, it is desirable that the luminance value of each of pixels be standardized or normalized in 256 gradations. Note that it is only required to be able to process an image and extract a feature point even without performing standardization or normalization of the luminance value. Therefore, standardization or normalization of the luminance value is not necessarily required.

It is also possible to perform processing called sub-pixellation. Sub-pixellation is image processing using a virtual unit (sub-pixel) that is finer than one pixel. In this processing, interpolated color tone or luminance value is embedded into sub-pixels. With this processing, it is possible to improve subsequent processing accuracy.

The internal sensor 102 is a sensor configured to detect and output an internal state of the moving body 10 and corresponds to an “internal state detection unit”. The internal sensor 102 can be configured, for example, as a module for detecting the moving amount of the moving body 10. Examples of the internal sensor 102 that can be employed include an encoder to detect a wheel rotation speed, a gyro sensor to detect a state of the moving body 10, an accelerometer, and an inertial measurement unit (IMU) combining the gyro sensor and the accelerometer. The IMU has a built-in geomagnetic sensor.

The moving body control unit 103 controls movement of the moving body 10 and an environment in an operation room, or the like. The moving body control unit 103 can move the moving body 10 based on a signal from an operation device arranged in the operation room. The moving body control unit 103 can also move the moving body 10 automatically based on a signal from the internal sensor 102 and a calculation result from the position estimation device 100.

The provisional position calculation unit 111 calculates a provisional position and an attitude of the moving body 10 based on a value detected by the internal sensor 102. As a technique to calculate a provisional position and an attitude, it is possible to use, for example, a known relative position estimation technique called dead reckoning. Dead reckoning is a technique in which a relative position and a relative attitude viewed from a previously calculated position are calculated from an internal sensor value, and the relative position and the relative attitude are added to the previously calculated position and attitude, thereby estimating a present position and attitude. Since this technique uses addition of relative positions, errors of provisional positions accumulate. In the present example, however, the position estimation unit 115 described below corrects the provisional position and attitude, making it possible to suppress accumulation of errors.

The map management unit 114 registers a position and an attitude of the moving body 10 at an imaging point in association with a surrounding image captured at the imaging point by the imaging unit 110 into a map database and manages the map database. The moving body that creates the map database and the moving body that uses the map database do not have to be the same. For example, data (position, attitude, and image) collected by the position estimation device 100 of a certain moving body obtained via a map management server 20 connected to the position estimation device 100 of a plurality of moving bodies 10 via a communication network CN can be utilized by the position estimation device 100 of another moving body. The map management server 20 retains a map database to manage data from the position estimation device 100 of each of the moving bodies. The map management server 20 can transmit a map database of a predetermined range to the map management unit 114 of the position estimation device 100 in response to a request from the position estimation device 100.

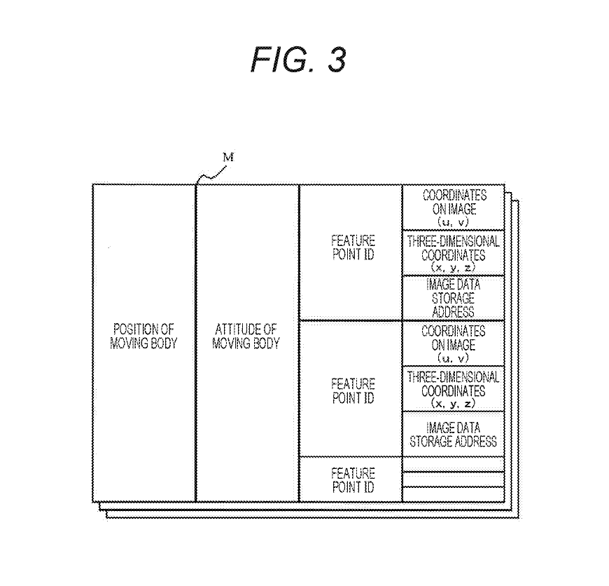

Exemplary creation of map image data M (refer to FIG. 3) to be registered on the map database will be described. An exemplary configuration of the map image data M will be described below with reference to FIG. 3.

For example, when the position and the attitude of the moving body 10 are known by a measurement means such as the provisional position calculation unit 111, the position estimation unit 115, triangulation, or satellite positioning, the map management unit 114 attaches an image ID (identifier) to the image detected by the imaging unit 110 and registers the image onto a map database. Furthermore, the map management unit 114 attaches an image ID also to the position and the attitude when the registered image is captured, and registers the position and the attitude onto the map database.

Furthermore, the map management unit 114 retrieves at least two images imaged at close positions to each other from among the images registered on the map database, and detects a feature point from each of the images. The map management unit 114 executes matching processing between the detected feature points with each other based on the imaging position and the attitude of each of the retrieved images. The map management unit 114 then calculates three-dimensional coordinates (3D coordinates) of the feature point on the map, that has been judged to be identical, based on the imaging position, the attitude, and parallax of the identical feature points of each of the retrieved images. In a case where the feature point detected in this manner has not been registered on the map database, the map management unit 114 registers the 3D coordinates of the feature point with a feature point ID, onto the map database. Furthermore, the on-the-image coordinates of the feature point on each of the retrieved images are registered onto the map database in association with the image ID and the feature point ID.

In a case where the 3D coordinates of the feature point has already been registered on the map database, the on-the-image coordinates of the feature point on each of the retrieved images are registered with the image ID and the feature point ID, onto the map database. With this procedure, on the map database, an image, a position and an attitude at imaging, on-the-image coordinates of the feature point detected from the image, and 3D coordinates of the feature points are registered onto the map database in association with an image ID and a feature point ID.

Regarding registration onto the map database, it is possible to use an image detected beforehand from a peripheral environment by the imaging unit 110 and registration is performed offline. Alternatively, online registration while the moving body 10 is moving would also be possible. Any of an offline method and an online method can be used for registration onto the map database. The offline method is a method whereby a feature point, or the like, is detected from an image captured beforehand and registered onto the map database. The online method is a method whereby a surrounding image is obtained while the moving body 10 is moving, and a feature point, or the like, is detected substantially real time from the obtained image and registered onto the map database.

When data (image, feature point, or the like) are registered onto the map database with the online method, the map management unit 114 checks whether there is an image registered at a position in a neighborhood of a position calculated by the provisional position calculation unit 111 or the position estimation unit 115. If there is no corresponding image, it is possible to detect a feature point by the tracking unit 112 or the feature point number management unit 113, or to detect the feature point from an entire image and register the detected feature point onto the map database.

Based on the provisional position and the attitude calculated by the provisional position calculation unit 111, the tracking unit 112 as a “feature point tracking unit” converts on-the-image coordinates of a previous feature point managed by the feature point number management unit 113, into on-the-image coordinates of a present image detected by the imaging unit 110. The tracking unit 112 detects a feature point from a neighborhood of the on-the-image coordinates of the present image detected by the imaging unit 110 and executes matching between the detected feature point and the previous feature point, thereby tracking the previous feature point managed by the feature point number management unit 113, on the present image detected by the imaging unit 110. Details of tracking processing will be described below.

The feature point number management unit 113 checks the number of feature points that has been determined as tracking targets by the tracking unit 112 and manages the number such that the number of feature points is the prescribed number that has been set beforehand. The feature point as a tracking target can also be referred to as a tracking target point. In a case where the number of feature points as tracking targets is less than the prescribed number, the feature point number management unit 113 extracts a feature point from the map database managed by the map management unit 114 and adjusts such that the number of feature points as tracking targets is the prescribed number. Even when the number of feature points as tracking targets is the prescribed number, in a case where arrangement of individual feature points might deteriorate position estimation accuracy, a feature point that would contribute to position estimation accuracy improvement is extracted from the map database and exchanges feature points as tracking targets. Details will be described below.

The position estimation unit 115 uses on-the-image coordinates of the feature point managed by the feature point number management unit 113 and calculates a direction in which the feature point is observed on the moving body coordinate system. The position estimation unit 115 corrects the provisional position and the attitude calculated by the provisional position calculation unit 111 such that the direction corresponds to the direction calculated from the 3D coordinates of the feature point.

An exemplary method for correcting the provisional position and the attitude will be described. Herein it is assumed, for example, that 3D coordinates of the feature point (feature point ID(i)) managed by the feature point number management unit 113 are represented by a vector p(i), a direction in which a feature point calculated from on-the-image 2D coordinates of the feature point is observed is represented by a vector m(i), a true position of the moving body 10 is represented by a vector t, and a true attitude of the moving body 10 is represented by rotation matrix R. The vector t indicating the position and the R indicating the attitude are calculated such that an evaluation function represented by the following Formula 1 becomes minimum.

$${\sum }_{i} {‖ p ( i ) - \{ {( p ( i ) - t )}^{T} m ( i ) \} m ( i ) - t ‖}^{2} \qquad [ Formula 1 ]$$

When a direction in which a feature point is observed is represented by a line segment, the above-described Formula 1 represents a sum of the squares of a Euclidean distance on the 3D coordinates of the line segment and the feature point. Other distances such as a Mahalanobis distance may be used instead of the Euclidean distance.

As a technique to minimize the evaluation function represented by Formula 1, it is possible, for example, to use the Levenberg-Marquardt Method, which is a known non-linear minimization technique. Techniques are not limited to this. It is possible to use other minimization method such as a known steepest descent method.

As initial values of the vector t representing a position and the R representing an attitude when the minimization technique is applied, it is desirable to use the provisional position and the attitude calculated by the provisional position calculation unit 111. Note that in order to apply the minimization technique, at least three feature points are required. Accordingly, in the present example, the prescribed number of feature points managed by the feature point number management unit 113 is set to “3” or more.

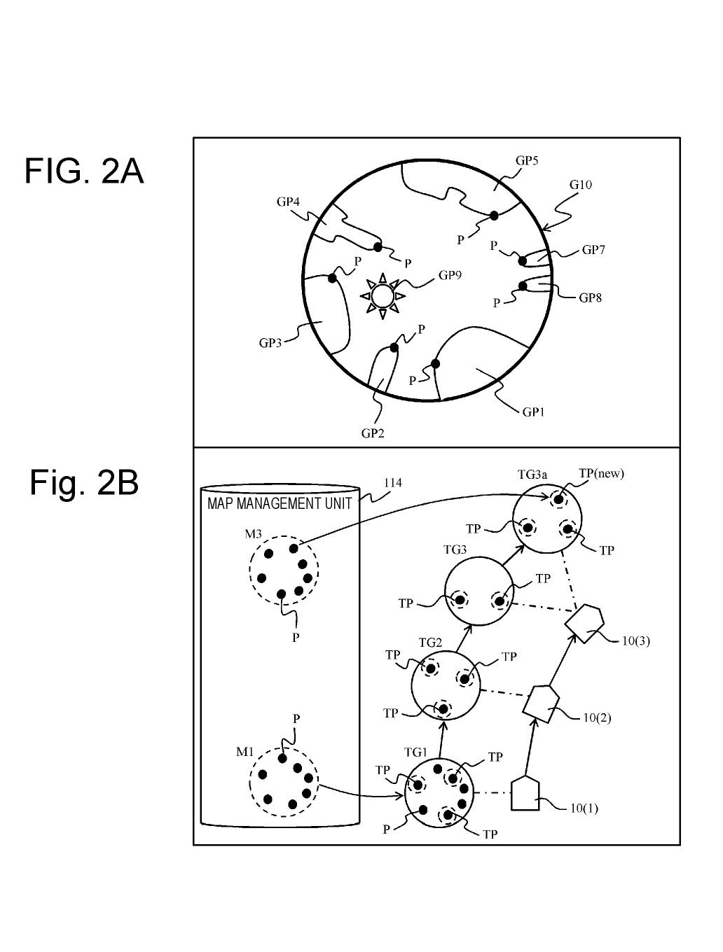

FIGS. 2(a) and 2(b) are diagrams illustrating exemplary images captured by the imaging unit 110 and exemplary feature points. When outdoor landscape is imaged upwardly from an upper portion of the moving body 10 using the camera 101 having a wide-angle lens, it is possible to capture images GP1 to GP9 of various objects, as illustrated in FIG. 2(a), such as buildings around the moving body 10.

The images GP1 to GP8 are structure images illustrating a whole or a portion of a building. The image GP09 is an image of the sun. The images that can be tracking targets, namely, GP1 to GP8, are positioned on a peripheral portion of the wide-angle lens. The sun GP9 is positioned closer to an inner portion. Accordingly, outlines of the various objects are relatively clear. In the present example, a feature point P is detected from outlines of the images GP1 to GP8, namely, the images of various object.

FIG. 2(b) a schematically illustrates a method to estimate the position of the moving body 10. The moving body 10 is assumed to move in an order of a sign 10(1), a sign 10(2), and a sign 10(3). Initially at a moving body position 10(1), a feature point P is extracted from a captured image TG1, to undergo matching processing against the feature point regarding a map image managed by the map management unit 114.

Among the feature points detected from the image TG1 captured at a first position, a feature point having a maximum matching likelihood with a feature point detected from map image data M1 already managed in the neighborhood of the first position, is selected as a feature point TP as a tracking target. The feature point TP as a tracking target corresponds to “a predetermined feature point” and the prescribed number N (e.g. three) of feature points are selected being apart from each other, for example, by a predetermined angle or more in a circumferential direction.

The position estimation device 100 captures an image TG2 for the time of movement of the moving body 10 to a second position 10(2), executes matching processing between a feature point detected from the image TG2 and the feature point TP as a tracking target, and tracks the feature point.

When the moving body 10 further moves from the second position 10(2) to a third position 10(3), the position estimation device 100 captures an image TG3 of the peripheral environment and detects a feature point as a tracking target. In a case where the number of feature points as tracking targets is less than a prescribed number at this time, the position estimation device 100 adds a feature point TP (new) as a new tracking target, from map image data M3 managed by the map management unit 114. The map image data M3 is the data that have been imaged in the neighborhood of the third position 10(3) and stored, and include the plurality of feature points P. The position estimation device 100 selects a feature point as a new tracking target from the map image data M3 such that the number of feature points as tracking targets is a prescribed number. With this configuration, the position estimation device 100 obtains an image TG3a having the prescribed number of feature points TP as tracking targets. In this manner, the position estimation device 100 according to the present example is configured to be able to estimate a position with relatively low load by tracking a prescribed number of feature points as tracking targets.

FIG. 3 is an exemplary configuration of the map image data M managed by the map management unit 114. The map image data M associates, for example, position information of a moving body when the image is captured, attitude of the moving body when the image is captured, and information regarding a feature point detected from the captured image, with each other. The information regarding the feature point includes a feature point ID for identifying the feature point, coordinates of the feature point on the image, 3D coordinates of the feature point, and storage address for captured image data.

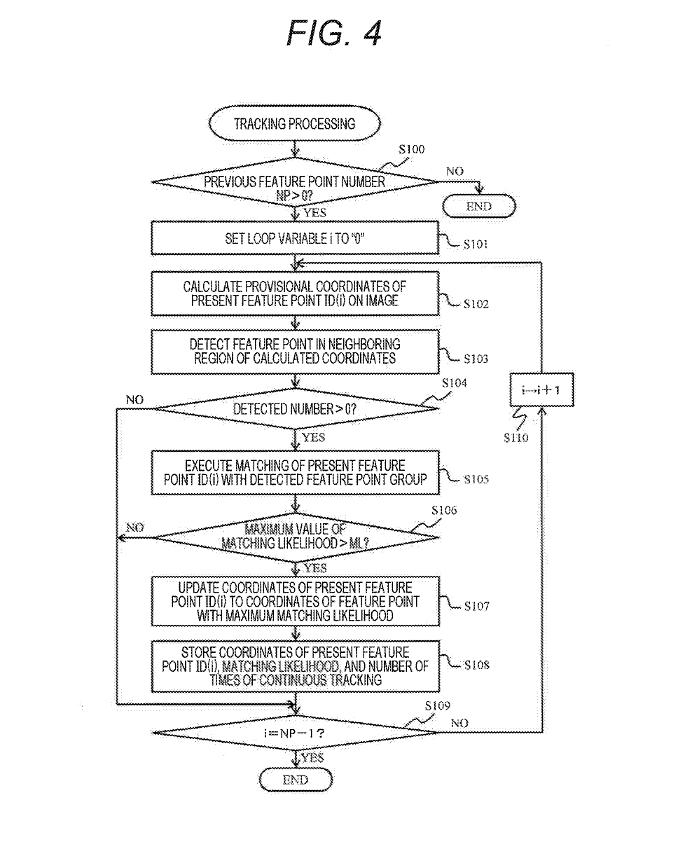

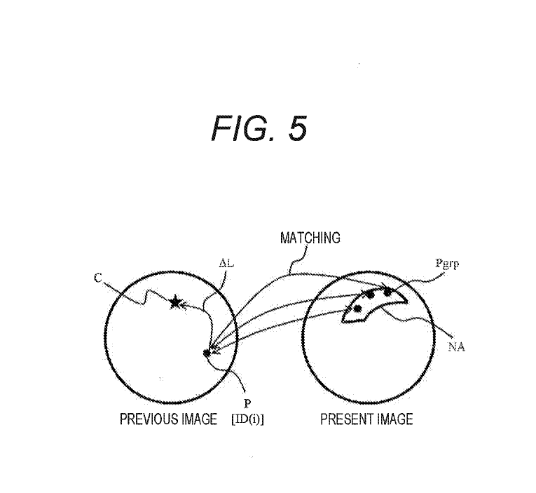

FIG. 4 illustrates tracking processing executed by the tracking unit 112. FIG. 5 schematically illustrates tracking processing. In FIG. 4, the tracking unit 112 will be an operating subject for description. Alternatively, however, the position estimation device 100 can be an operating subject for description.

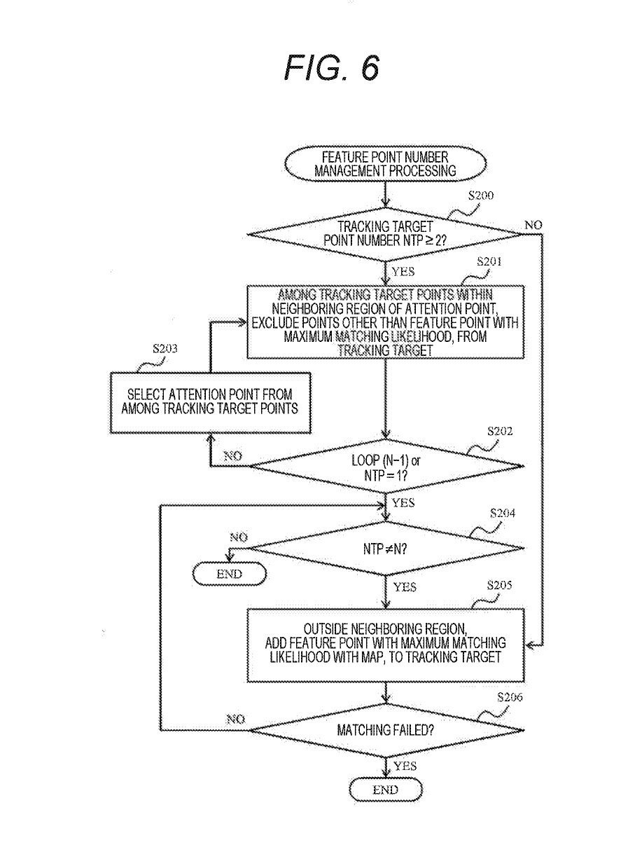

First, the tracking unit 112 determines (S100) whether there are one or more feature points managed by previous feature point number management processing (described below in FIG. 6). In a case where there is no previous feature point (S100: NO), it means there is no tracking target. Accordingly, the present processing is finished.

In a case where there are one or more previous feature points (S100: YES), the tracking unit 112 sets a loop variable i to zero (i=0) and enters into (S101) loop processing (S102 to S109) in order to track the feature point.

At the start of i-th loop processing, the tracking unit 112 calculates a provisional on-the-image coordinates of the feature point with the feature point ID(i) on an image detected by the imaging unit 110 (S102) on the present occasion by using the provisional position and the attitude calculated on the present occasion by the provisional position calculation unit 111 and by using 3D coordinates of a previous feature point (having feature point ID of ID(i)) managed by the feature point number management unit 113.

Processing of step S102 will be described with reference to FIG. 5. At step S102, a feature point P [ID(1)] on a previous image is moved to an on-the-image coordinates C by a moving amount ΔL calculated from an internal sensor value, and the on-the-image coordinates C is determined as provisional on-the-image coordinates of a feature point on a present image.

The tracking unit 112 detects (S103) a feature point in a neighboring region of the provisional on-the-image coordinates of the feature point having feature point ID(i) calculated at step S102.

Herein, the neighboring region corresponds to a “predetermined region”, namely, a region including emergence expectation coordinates on which the previous feature point is expected to emerge on the present occasion. The neighboring region is applied by calculating a region, on the on-the-image coordinates, that can be covered by the feature point of the feature point ID(i) when the provisional position and attitude are slightly changed in step S102. Other than this, a region in a rectangular or a circular shape having provisional on-the-image coordinates as a center may be set as an adjacent region. In a case where the feature point cannot be detected in the neighboring region, it is possible to expand the neighboring region and retry detecting the feature point.

Processing of step S103 will be described with reference to FIG. 5. A neighboring region NA is provided on the present image having the provisional on-the-image coordinates C as a center, a feature point group Pgrp is detected from the neighboring region NA, and matching processing is executed between the feature point group Pgrp and the feature point P [ID(1)] on the previous image.

The tracking unit 112 determines (S103) whether the feature point corresponding to the feature point having the feature point ID(i) has been detected at step S103. If no feature point has been detected (S103: NO), the tracking unit 112 excludes the feature point with the feature point ID(i) from tracking targets.

In a case one or more feature points as tracking targets have been detected (S104: YES), the tracking unit 112 executes matching processing between the detected feature point group and the previously detected feature point having the feature point ID(i), and calculates a matching likelihood for each (S105).

Examples of known matching processing techniques include pattern matching that defines the inverse of the Euclid distance of a feature quantity representing a luminance value pattern of a neighboring pixel of a feature point as a matching likelihood, and template matching that prepares a template window in the neighborhood of a feature point and defines correlation between each of pixels within the template window as a matching likelihood. In the present example, any matching technique can be employed as long as it can calculate a matching likelihood.

The tracking unit 112 preliminary sets a threshold ML as a reference of judging whether matching is successful and selects a feature point having the maximum matching likelihood which is larger than the threshold ML, among the feature points that have undergone matching processing at step S105 (S106). In a case where the maximum value of matching likelihood is the threshold ML or below (S106: NO), a feature point having the feature point ID(i) is excluded from the tracking target.

The tracking unit 112 updates the on-the-image coordinates of the feature point with the previous feature point ID(i) to on-the-image coordinates of the feature point selected at step S106 (S107). Furthermore, at step S107, the tracking unit 112 adds “1” to continuous tracking times of the feature point with the feature point ID(i).

The tracking unit 112 stores the on-the-image coordinates of the feature point with feature point ID(i), updated at step S107, the continuous tracking times, and the maximum value of matching likelihood calculated at step S105 (S108).

In a case where processing of steps S102 to S108 has been completed toward all feature points managed by the previous feature point number management processing (S109: YES), the tracking unit 112 finishes the tracking processing.

In a case where processing of steps S102 to S108 has not been completed toward all feature points managed by the previous feature point number management processing (S109: NO), the tracking unit 112 selects one feature point as a processing target, from among unprocessed feature points (S110), and applies processing of steps S102 to S108 to the selected feature point.

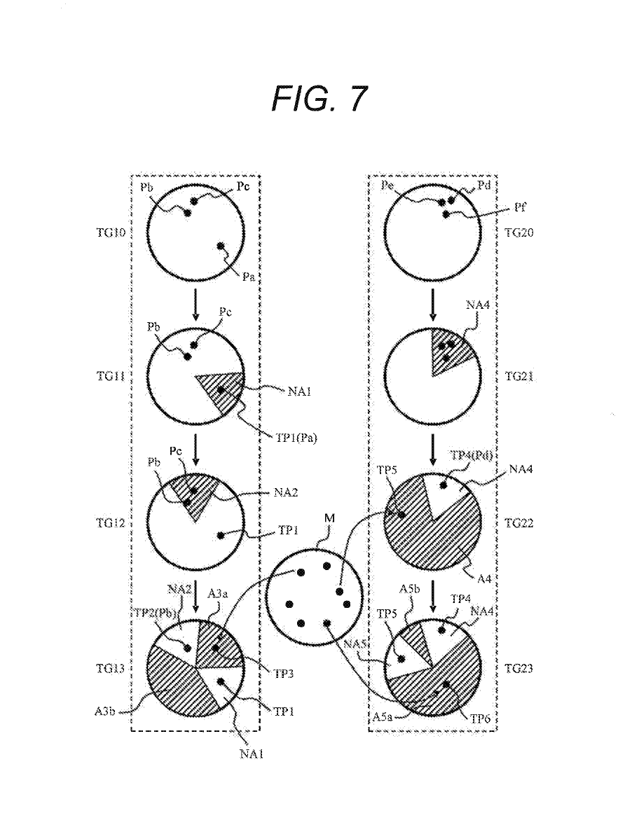

FIG. 6 illustrates feature point number management processing executed by the feature point number management unit 113. FIG. 7 schematically illustrates feature point number management processing when the prescribed number of feature points is set to three.

In a case where the number NTP of feature points successfully tracked by the tracking unit 112 is one or zero (S200: NO), the feature point number management unit 113 executes processing at step S205 to be described below. In a case where the number NTP of feature points successfully tracked by the tracking unit 112 is two or more (S200: YES), the feature point number management unit 113 executes loop processing of step S201 to S203 to be described below.

The feature point number management unit 113 gives attention to one point among the feature points successfully tracked by the tracking unit 112, and sets a neighboring region for an attention point (S201). The neighboring region in the present example is defined as a region obtained as follows: a deviation angle of the attention point on the image detected by the imaging unit 110±360°/(4×(feature point prescribed number N)).

Among the successfully tracked feature points included in a neighboring region of the attention point, feature points besides the feature point that has the maximum matching likelihood stored in tracking processing are excluded from tracking targets for next tracking processing.

In a case where there are two or more feature points having the maximum matching likelihood, feature points besides the feature point having the maximum number of continuous tracking times stored in the tracking processing (by the tracking unit 112) are excluded from tracking targets.

Description will continue with reference to FIG. 7. As illustrated in a left-side example in FIG. 7, there is a case of an image TG10 in which two feature points, namely, a feature point Pb and a feature point Pc, are close to each other. In this case, when a feature point Pa positioned apart from any of the two feature points Pb and Pc is selected, there is no other feature point in a neighboring region NA1 of the feature point Pa, as illustrated in an image TG11 indicating a processing sequence. Accordingly, the selected feature point Pa is left as a tracking point TP1 as a tracking target.

Subsequently, in an image TG12 indicating a succeeding processing sequence, since other feature point Pc is included in a neighboring region NA2 of the selected feature point Pb, the feature point number management unit 113 determines a feature point to be excluded from tracking targets based on the matching likelihood and continuous tracking times.

Description follows with reference back to FIG. 6. In a case where the feature point number management unit 113 determines that steps S201 to S203 have been completed toward all feature points successfully tracked by previous tracking processing, or that the number of feature points as tracking targets for next tracking processing becomes one (S202: YES), the feature point number management unit 113 exits loop processing (S201 to S203). In FIG. 7, for example, a state immediately after completion of an image TG12 of the processing sequence and a state immediately after completion of an image TG21 of the processing sequence indicated on the right side correspond to a case in which determination is YES in process S202.

The feature point number management unit 113 selects one feature point as an attention point (S203) from among other successfully tracked feature points that have not been excluded from tracking targets for the next tracking processing, and executes loop processing (S201 to S203).

The feature point number management unit 113 checks whether the number of feature points as tracking targets for the next tracking processing is the prescribed number (S204). In a case the number of feature points as tracking targets reaches the prescribed number (S204: NO), the feature point number management unit 113 finishes the feature point number management processing.

In a case where the number of feature points as tracking targets has not reached the prescribed number (S204: YES), the feature point number management unit 113 adds a feature point outside the neighboring region on the image of the tracking target point for the next tracking processing (S205). The region besides the neighboring region of the feature point as a tracking target corresponds to “another region (other regions) besides a predetermined region”.

Specifically, the feature point number management unit 113 selects an image captured at a position closest to the provisional position calculated by the provisional position calculation unit 111, among the images of the map database managed by the map management unit 114. The feature point number management unit 113 executes matching processing against the selected image, outside of the neighboring region on the image of the feature point as a tracking target remaining at that stage, and adds a feature point having the maximum matching likelihood as a tracking target (S205).

The neighboring region can be set with a technique similar to what has been described at step S201. Any matching technique can be employed as long as it can calculate the matching likelihood. In FIG. 7, for example, an image TG13 of the processing sequence and an image TG23 of the processing sequence correspond to step 205.

In a case where the maximum value of matching likelihood is not the threshold ML or more, the feature point number management unit 113 judges that matching processing has failed (S206: YES), and finishes the feature point number management processing without adding a new feature point to tracking targets. In contrast, in a case where the maximum value of matching likelihood is larger than the threshold ML (S206: NO), the feature point number management unit 113 adds the feature point having the maximum matching likelihood to the tracking targets and checks the number of tracking target points again (S204).

FIG. 7 schematically illustrates a state in which a feature point as tracking target is determined and in a case where the prescribed number has not been satisfied, a feature point as a tracking target is added.

The processing sequence images of TG10 to TG13 in one of the examples, include the two feature points Pb and Pc being close to each other and the feature point Pa being positioned apart from the others (TG10).

As described above, when paying attention to the feature point Pa positioned apart from the others, the neighboring region NA1 of the feature point Pa does not include other feature points. Accordingly, the feature point Pa is selected as a tracking target (TG11).

When the next feature point Pb is viewed with attention, the neighboring region NA2 of the feature point Pb includes another feature point Pc. Accordingly, among the feature points Pb and Pc, the feature point (herein, Pb is assumed) having the maximum matching likelihood is selected as a tracking point TP2 as a tracking target (TG12).

In the present example, the prescribed number N is three. Accordingly, three feature points are to be tracked. However, only two feature points have been selected yet. To cope with this, a third feature point is selected among other feature points existing in other regions A3a and A3b besides the neighboring regions NA1 and NA2 of the tracking points TP1 (Pa) and TP2 (Pb) selected as tracking targets. The feature point number management unit 113 selects one feature point having the maximum matching likelihood with respect to a feature point, included in the map image data M, corresponding to a provisional position, among other feature points existing in other regions A3a and A3b, and then, adds the selected feature point as a tracking point TP3 as a tracking target.

The processing sequence images (TG20 to TG23) in the other example, include three feature points Pe, Pd, and Pf being close to each other within a certain neighboring region NA4 (TG20). Accordingly, the feature point number management unit 113 selects a feature point Pd having the maximum matching likelihood as a feature point TP4 as a tracking target, from among the three feature points (TG21).

Following the above-described procedure, a second feature point TP5 is selected from another region A4 besides the neighboring region NA4 of the feature point TP4 as a tracking target (TG22). Furthermore, the feature point number management unit 113 selects a third feature point TP6 from other regions A5a and A5b besides the neighboring regions NA4 and NA5 of the tracking points TP4 and TP5 as tracking targets (TG23).

According to the present example with this configuration, it is only required to track the prescribed number of feature points. Accordingly, it is possible to estimate the position of the moving body 10 with relatively low processing load.

According to the present example, the feature point needed for position estimation (feature point as a tracking target) is selected based on a predetermined geometric condition, making it possible to enhance position estimation accuracy. In the present example, as one geometric condition, feature points are selected to be positioned apart from each other by a predetermined angle in a circumferential direction. Accordingly, it is possible to estimate the position of the moving body 10 based on distances and directions among the three feature points and the moving body 10, with relatively high accuracy. In the present example, as another condition, another feature point as a tracking target is selected from a region besides the neighboring region set to a certain feature point as a tracking target. Therefore, there are certain distances among individual feature points as tracking targets, corresponding to the size of the neighboring region. Furthermore, in the present example, the neighboring region is defined as a region obtained as: a deviation angle of the feature point (attention point) as a tracking target±360°/(4×(prescribed number N)). Accordingly, when the prescribed number N is “3”, the feature points as tracking targets are apart from each other by at least 30 degrees.

In this manner, according to the present example, it is possible to manage the feature points as tracking targets to be the prescribed number based on a relatively simple algorithm, making it possible to promptly respond to a varying movement status and estimate the position of the moving body 10.

### Example 2

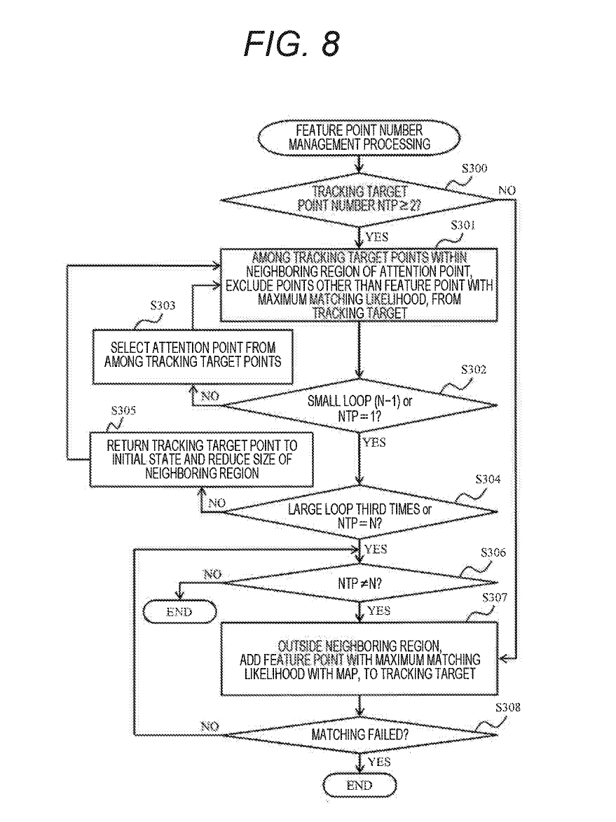

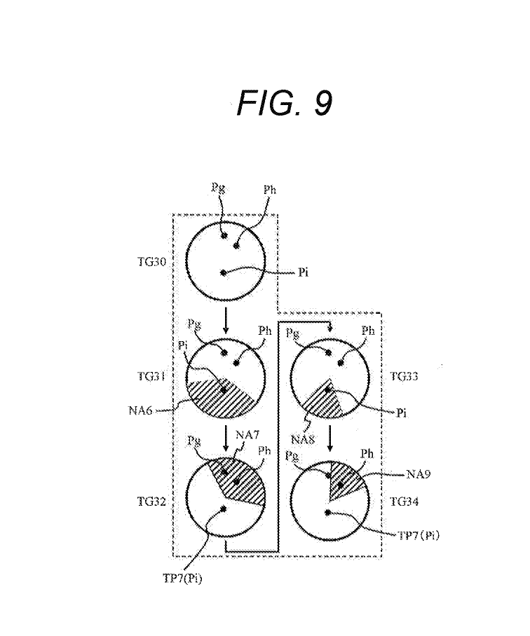

A second example will be described with reference to FIGS. 8 and 9. The present example corresponds to a modification of the first example and extracts a feature point (tracking target point) more robustly than the procedure described in the first example.

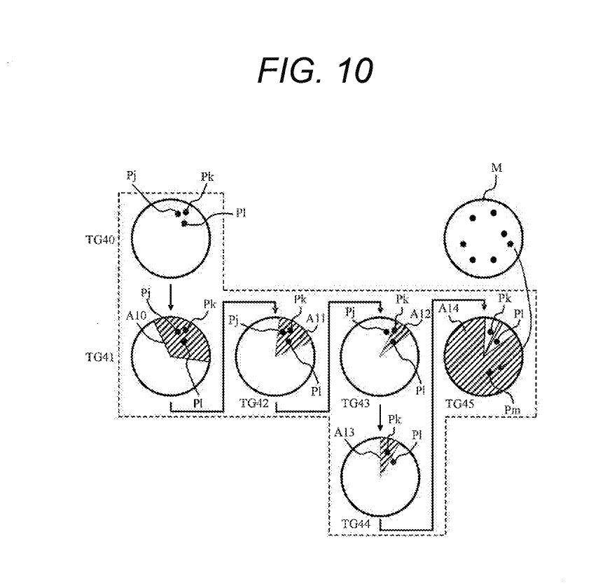

FIG. 8 is a flowchart illustrating feature point number management processing according to the present example. FIGS. 9 and 10 are diagrams schematically illustrating feature point number management processing according to the present example when the prescribed number N of feature points is set to three. Among the feature point management processing illustrated in FIG. 8, each of steps S300, S301, S302, S303, S306, S307, and S308 respectively corresponds to each of steps S200, S201, S202, S203, S204, S205, and S206 described in FIG. 6. Note that configurations of neighboring regions, or the like, differ from the case of the first example.

In a case where the number of feature points successfully tracked in tracking processing is one or zero (S300: NO), the feature point number management unit 113 executes processing of step S305. In a case where the number of feature points successfully tracked is two or more (S300: YES), the feature point number management unit 113 executes loop processing of steps S301 to S305.

At step S301, the feature point number management unit 113 gives attention to one point among the feature points successfully tracked in the tracking processing, and sets a neighboring region of the attention point. The neighboring region at the start of looping is defined as a region obtained as follows: a deviation angle of the attention point on the image detected by the imaging unit 110±360°/(2×(feature point prescribed number N)).

Among the successfully tracked feature points included in the neighboring region of the attention point, feature points besides the feature point having the maximum matching likelihood stored in tracking processing are excluded from tracking targets for next tracking processing (S301). In a case where there are two or more feature points having the maximum matching likelihood, feature points besides the feature point having the maximum number of continuous tracking times stored by the tracking unit 112 are excluded from tracking targets.

At step S302, in a case where steps S301 to S303 have been completed toward all feature points successfully tracked by previous tracking processing, or where the number of feature points as tracking targets for the next tracking processing becomes one (S302: YES), the feature point number management unit 113 exits loop processing (S301 to S303).

At step S303, the feature point number management unit 113 selects an attention point from among other feature points that have not been excluded from tracking targets for the next tracking processing, and executes loop processing (S301 to S303). Processing sequence images TG31, TG32, TG33, and TG34 in FIG. 9 and processing sequence images TG41, TG42, TG43, and TG44 in FIG. 10 correspond to loop processing S301 to S303.

In a case where the number of tracking target points NTP meets the prescribed number N as a result of loop processing (S301 to S303) executed in the set neighboring region, or a third round of loop processing S301 to S305 has been completed (S304: YES), the feature point number management unit 113 exits the loop processing (S301 to S305), and in a case where the above is not applied (S304: NO), processing moves on to step S305.

At S305, the feature point number management unit 113 returns the tracking target point to a state of starting of the feature point number management processing (initial state), reduces the size of the neighboring region, and moves on to the loop processing (S301 to S303).

The neighboring region has been set to be gradually reduced such that the deviation angle of attention point±360°/(4×(feature point prescribed number N)) at completion of first round of loop processing S301 to S303, and that the deviation angle of attention point±360°/(8×(feature point prescribed number N)) at completion of second round of loop processing S301 to S303. Transition from the processing sequence image TG32 to the image TG33 in FIG. 9, transition from the processing sequence image TG41 to the image TG42 in FIG. 10, and the transition from TG42 to TG43 correspond to step S305.

At S306, in a case where, at the present moment, the number of feature point NTP as tracking targets for the next tracking processing corresponds to the prescribed number N (S306: YES), the feature point number management unit 113 finishes the present processing.

At S307, the feature point number management unit 113, at the present moment, selects an image captured at a position closest to the provisional position among the images of the map database managed by the map management unit 114, outside of the neighboring region on the image, of the tracking target point for the next tracking processing. The feature point number management unit 113 executes matching processing with the selected image, outside of the neighboring region on the image, of the tracking target point remaining at the time of step S307, and adds a feature point having the maximum matching likelihood as a tracking target.

Herein, the neighboring region at step S307 corresponds to the neighboring region with the size set in step S305 at the time of exit of loop processing (S301 to S305). Any matching technique can be employed as long as it can calculate the matching likelihood. The processing sequence image TG45 in FIG. 10 corresponds to step S307.

In a case where, at step S308, the maximum value of matching likelihood cannot achieve the threshold ML or more (S308: YES), the feature point number management unit 113 judges that matching processing has failed, and finishes the feature point number management processing without adding a new feature point to the tracking targets. In contrast, in a case where the maximum value of matching likelihood is larger than the threshold ML (S308: NO), the feature point number management unit 113 adds the feature point having the maximum matching likelihood as the tracking targets and re-checks the number of tracking target points (S306).

The present example configured in this manner has functional effects similar to the first example. Furthermore, in the present example, it is configured such that the size of the neighboring region that is a search region for searching for the feature point as tracking target is variable and gradually reduced. Accordingly, it is possible to select the feature points of the number required for position estimation as tracking targets even when the number of feature points included in the captured image is small. With this configuration, it is possible to enhance reliability and accuracy in position estimation.

The present invention is not intended to be limited to the above-described examples. Persons skilled in the art can make various types of addition, modification within a scope of the present invention. For example, it is possible to configure such that a captured image is divided into regions with a predetermined central angle and that a feature point having the highest matching likelihood in each of the regions is selected as a tracking target. In this case, however, in a case where there is a region having no available feature points, it might be difficult to select a feature point as a tracking target in that region, and might deteriorate the position estimation accuracy.

In each of the examples, the prescribed number of feature points as tracking targets is “3” in description. However, the number is not limited to “3”. The prescribed number may be the value of four or more. Moreover, the size of the neighboring region is described merely as an exemplification.

### REFERENCE SIGNS LIST

10 moving body
100 position estimation device
101 camera
102 internal sensor
103 moving body control unit
110 imaging unit
111 provisional position calculation unit
112 tracking unit
113 feature point number management unit
114 map management unit
115 position estimation unit

1. A moving body position estimation device configured to estimate a position of a moving body, the moving body position estimation device comprising:
an imaging unit attached to the moving body and configured to image a peripheral environment;
a map management unit configured to manage coordinates of a feature point extracted from a captured image of the peripheral environment in association with a map;
a feature point tracking unit configured to track a predetermined feature point selected by a predetermined reference among the feature points extracted from the image captured by the imaging unit;
a feature point number management unit configured to manage such that the number of predetermined feature points tracked by the feature point tracking unit is a prescribed number; and
a position estimation unit configured to estimate a position based on coordinates of the predetermined feature point tracked by the feature point tracking unit and based on the map managed by the map management unit.

2. The moving body position estimation device according to claim 1, comprising a provisional position calculation unit configured to calculate a provisional position and an attitude of the moving body based on a detection value of an internal state detection unit configured to detect an internal state of the moving body and based on a position estimated by the position estimation unit,
wherein the feature point tracking unit tracks the predetermined feature point using the provisional position and the attitude calculated by the provisional position calculation unit and using the image captured by the imaging unit.

3. The moving body position estimation device according to claim 2,
wherein the map management unit manages, in association with the map, an image of a peripheral environment, an imaging position and an attitude when the image is captured, on-the-image coordinates of the feature points on the image, extracted from the image, and three-dimensional coordinates on a moving body coordinate system of the feature points.

4. The moving body position estimation device according to claim 3,
wherein the feature point tracking unit calculates emergence expectation coordinates on which a predetermined feature point is expected to emerge on an image based on the provisional position calculated by the provisional position calculation unit,
extracts a feature point from an image within a predetermined region set to include the emergence expectation coordinates,
calculates a matching likelihood between the extracted feature point and the predetermined feature point, and
uses a feature point having the maximum matching likelihood as the predetermined feature point, among the feature points extracted within the predetermined region.

5. The moving body position estimation device according to claim 3,
wherein, in a case where the feature point number management unit has determined that the number of predetermined feature points is less than the prescribed number, the feature point number management unit executes matching processing between an image of the peripheral environment managed by the map management unit and the image captured by the imaging unit, and accordingly adds a feature point having a matching likelihood of a predetermined threshold or above and meeting a predetermined reference, as a new predetermined feature point.

6. The moving body position estimation device according to claim 3,
wherein, in a case where the feature point number management unit has determined that the number of predetermined feature points is the prescribed number, the feature point number management unit
checks whether each of the predetermined feature points meets a predetermined reference,
judges that the feature point that does not meet the predetermined reference is not the predetermined feature point, excludes the feature point from tracking targets for the feature point tracking unit,
executes matching processing between the image of the peripheral environment managed by the map management unit and the image captured by the imaging unit, and accordingly adds a feature point having a matching likelihood of a predetermined threshold or above and meeting the predetermined reference, as a new predetermined feature point.

7. The moving body position estimation device according to claim 1,
wherein the predetermined reference is defined as a predetermined geometric condition required to estimate a position based on three-dimensional coordinates of the prescribed number of predetermined feature points.

8. The moving body position estimation device according to claim 7,
wherein the predetermined geometric condition is a condition in which the prescribed number of predetermined feature points are separated by a predetermined angle or more in a circumferential direction with respect to a center of the image as a reference.

9. The moving body position estimation device according to claim 8,
wherein the predetermined geometric condition is selecting a feature point existing in another region besides a predetermined region set to include the predetermined feature point.

10. The moving body position estimation device according to claim 9,
wherein a size of the predetermined region related to the predetermined feature point is variable.

11. The moving body position estimation device according to claim 1,
wherein the imaging unit is mounted upwardly on an upper surface of the moving body.

12. A moving body position estimation method for estimating a position of a moving body using a computer,
the computer being attached to the moving body and being connected to an imaging unit configured to image a peripheral environment, the moving body position estimation method comprising steps to be executed on the computer, the steps comprising:
a tracking step of tracking a predetermined feature point selected by a predetermined reference, among feature points extracted from an image captured by the imaging unit;
a feature point management step of managing such that the number of predetermined feature points is the prescribed number; and
a position estimation step of estimating a position based on predetermined map data in which coordinates of a feature point extracted from the captured image of the peripheral environment are associated with a map and based on coordinates of the predetermined feature point.

13. The moving body position estimation method according to claim 12, comprising a provisional position calculation step of calculating a provisional position and an attitude of the moving body based on a detection value of an internal state detection unit configured to detect an internal state of the moving body and based on a position estimated by the position estimation step,
wherein the tracking step tracks the predetermined feature point using the provisional position, the attitude, and the image captured by the imaging unit.

14. The moving body position estimation device according to claim 3,
wherein the feature point management step
compares the number of predetermined feature points with the prescribed number,
in a case where the feature point management step has determined that the number of predetermined feature points is less than the prescribed number, the feature point management step
executes matching processing between the image of the peripheral environment managed by the predetermined map data and the image captured by the imaging unit and accordingly adds a feature point having a matching likelihood of a predetermined threshold or above and meeting the predetermined reference as a new predetermined feature point,
in a case where the feature point management step has determined that the number of predetermined feature points is the prescribed number, the feature point management step checks whether each of the predetermined feature points meets a predetermined reference,
judges that the feature point that does not meet the predetermined reference is not the predetermined feature point and excludes the feature point from tracking targets for the tracking step, and
executes matching processing between the image of the peripheral environment managed by the map data and the image captured by the imaging unit and accordingly adds a feature point having a matching likelihood of a predetermined threshold or above and meeting the predetermined reference as a new predetermined feature point.
